(19) United States
(12) Patent Application Publication
(10) Pub. No.: US 2026/0332986 A1
(43) Pub. Date: Oct. 22, 2026

(54) Portable Commercial Tracker Motion Detection System

(71) Applicant: Ribbiot, Inc., Huntington Beach, CA (US)

(72) Inventors: Christopher Green, Austin, TX (US); Michael Mazzoleni, Beaverton, OR (US); JD Martin, Austin, TX (US)

(21) Appl. No.: 19/184,446

(22) Filed: Apr. 21, 2025

(51) Int. Cl. H04W 4/029; G06Q 10/08

(52) U.S. Cl. CPC H04W 4/029; G06Q 10/08

(57) ABSTRACT

A commercial equipment tracker state machine for commercial equipment trackers detects motion events. The current motion state of the commercial equipment trackers is determined with the state machine. The state machine utilizes data from one or more of Global Navigation Satellite Systems (GNSS), radio systems (e.g. LTE, Wi-Fi, Bluetooth Low Energy, etc.), inertial measurement units (e.g., accelerometers or IMUs), or other such systems for determination of the state. The techniques of the state machine allow for accurate determination of motion events of commercial equipment trackers while rejecting both false positive and false negative events.

### FIELD OF TECHNOLOGY

This patent application relates generally to electronic systems and devices, and more specifically to commercial equipment tracking systems and devices.

### BACKGROUND

Commercial assets, such as equipment used on jobsites, are often critical to projects. Due to the expense of various assets, such assets are often shared between jobsites. Accordingly, proper tracking and determination of movement states of such assets provides significant logistical advantages, reduces delay, and reduces cost from lost equipment. However, such trackers are often poor at providing reliable movement data. Due to cost reasons, trackers often do not include a full suite of location detection components and so losing track of the location of such trackers is common.

### SUMMARY

Described are methods and systems for commercial equipment tracking. In a certain embodiment, a commercial equipment tracking system is described.
Clause 1. A commercial equipment tracking system, comprising: a first commercial equipment tracking device, configured to couple to a first equipment and comprising: a first communications module; a first processor, communicatively coupled to the first communications module and configured to perform operations comprising: determining, during a first time period, that the first equipment is in a zero motion state; receiving, during a second time period later than the first time period, first data of a first protocol; determining, based on the first data received during the second time period, that the first equipment is in a second motion state; communicating, via the first communications module to a server, first state data indicating that the equipment is in the second motion state; receiving, during a third time period later than the second time period, second data of a second protocol different from the first protocol; determining, based on the second data and a lack of further first data, that the first equipment is in a first motion state; determining, during a fourth time period later than the third time period, a lack of further first data for a first threshold period of time; determining, based on the lack of further first data for the first threshold period of time, that the first equipment is in a zero motion state; and communicating, via the first communications module to the server, second state data indicating that the equipment is in the zero motion state.
Clause 2. The commercial equipment tracking system of clause 1, wherein the first commercial equipment tracking device further comprises: a first data receiver, configured to receive the first data of the first protocol.
Clause 3. The commercial equipment tracking system of clause 2, wherein the first commercial equipment tracking device further comprises: a second data receiver, configured to receive the second data of the second protocol.
Clause 4. The commercial equipment tracking system of clause 2, wherein the second data of the second protocol is received by the first communications module from an associated device.
Clause 5. The commercial equipment tracking system of clause 1, wherein the first commercial equipment tracking device further comprises: a third data receiver, configured to receive the third data of a third protocol, and wherein the operations further comprise: receiving, at the third time period, third data of the third protocol, wherein the determining that the first equipment is in the first motion state is further based on the third data.
Clause 6. The commercial equipment tracking system of clause 1, wherein the first data and the second data is received by the first communications module from an associated device coupled to second equipment, and wherein: the determining the second motion state further comprises determining that the second equipment is in the second motion state; and the determining the first motion state further comprises determining that the second equipment is in the first motion state.
Clause 7. The commercial equipment tracking system of clause 1, wherein the operations further comprise: receiving, during a fifth time period later than the fourth time period, second data of the second protocol and/or third data of a third protocol; and determining, based on the second data and/or the third data received during the fifth time period, that the first equipment is in a third motion state.
Clause 8. The commercial equipment tracking system of clause 7, wherein the operations further comprise: determining that the first equipment is in the third motion state for a second threshold period of time. determining, based on the first equipment being determined to be in the third motion state for the second threshold period of time, that the first equipment is in the zero motion state; and communicating, via the first communications module to the server, third state data indicating that the equipment is in the zero motion state.
Clause 9. The commercial equipment tracking system of clause 7, wherein the operations further comprise: receiving, during a sixth time period later than the fifth time period, first data of the first protocol, second data of the second protocol, and/or third data of the third protocol; determining, based on the first data, second data, and/or third data received during the sixth time period, that the first equipment is in the second motion state; communicating, via the first communications module to the server, third state data indicating that the equipment is in the second motion state.
Clause 10. The commercial equipment tracking system of clause 7, wherein the first protocol is a Global Navigation Satellite System protocol, the second protocol is an inertial measurement protocol, and the third protocol is a communications signal based protocol.
Clause 11. A method of operating a first commercial equipment tracking device coupled to a first equipment, the method comprising: determining, during a first time period, that the first equipment is in a zero motion state; receiving, during a second time period later than the first time period, first data of a first protocol; determining, based on the first data received during the second time period, that the first equipment is in a second motion state; communicating, via a first communications module of the first commercial equipment tracking device to a server, first state data indicating that the equipment is in the second motion state; receiving, during a third time period later than the second time period, second data of a second protocol different from the first protocol; determining, based on the second data and a lack of further first data, that the first equipment is in a first motion state; determining, during a fourth time period later than the third time period, a lack of further first data for a first threshold period of time; determining, based on the lack of further first data for the first threshold period of time, that the first equipment is in a zero motion state; and communicating, via the first communications module to the server, second state data indicating that the equipment is in the zero motion state.
Clause 12. The method of clause 11, wherein the first data of the first protocol is received with a first data receiver of the first commercial equipment tracking device.
Clause 13. The method of clause 12, wherein the second data of the second protocol is received with a second data receiver of the first commercial equipment tracking device.
Clause 14. The method of clause 12, wherein the second data of the second protocol is received by the first communications module from an associated device.
Clause 15. The method of clause 11, further comprising: receiving, at the third time period, third data of a third protocol, wherein the determining that the first equipment is in the first motion state is further based on the third data, and wherein the third data of the third protocol is received with a third data receiver of the first commercial equipment tracking device.
Clause 16. The method of clause 11, wherein the first data and the second data are received by the first communications module from an associated device coupled to second equipment, and wherein: the determining the second motion state further comprises determining that the second equipment is in the second motion state; and The determining the first motion state further comprises determining that the second equipment is in the first motion state.
Clause 17. The method of clause 11, further comprising: receiving, during a fifth time period later than the fourth time period, second data of the second protocol and/or third data of a third protocol; and determining, based on the second data and/or the third data received during the fifth time period, that the first equipment is in a third motion state.
Clause 18. The method of clause 17, further comprising: determining that the first equipment is in the third motion state for a second threshold period of time. determining, based on the first equipment being determined to be in the third motion state for the second threshold period of time, that the first equipment is in the zero motion state; and communicating, via the first communications module to the server, third state data indicating that the equipment is in the zero motion state.
Clause 19. The method of clause 17, further comprising: receiving, during a sixth time period later than the fifth time period, first data of the first protocol, second data of the second protocol, and/or third data of the third protocol; determining, based on the first data, second data, and/or third data received during the sixth time period, that the first equipment is in the second motion state; communicating, via the first communications module to the server, third state data indicating that the equipment is in the second motion state.
Clause 20. The method of clause 17, wherein the first protocol is a Global Navigation Satellite System protocol, the second protocol is an inertial measurement protocol, and the third protocol is a communications signal based protocol.

These and other examples are described further below with reference to figures.

### BRIEF DESCRIPTION OF THE DRAWINGS

The included drawings are for illustrative purposes and serve only to provide examples of possible structures and operations for the disclosed inventive systems, apparatus, methods, and computer program products for commercial equipment tracking. These drawings in no way limit any changes in form and detail that may be made by one skilled in the art without departing from the spirit and scope of the disclosed implementations.

FIG. 1 illustrates a block diagram of an example system, in accordance with certain embodiments.

FIG. 2 illustrates another block diagram of an example system, in accordance with certain embodiments.

FIG. 3 illustrates a block diagram of a state machine, in accordance with certain embodiments.

FIGS. 4 and 5 are flowcharts illustrating examples of operating a commercial equipment tracking state machine, in accordance with certain embodiments.

FIGS. 6, 7, 8A, 8B, and 8C illustrate examples of operating a commercial equipment tracking state machine, in accordance with certain embodiments.

FIG. 9 illustrates a perspective view of a commercial equipment tracking device, in accordance with certain embodiments.

FIG. 10 illustrates a block diagram of an example computing system, in accordance with certain embodiments.

### DETAILED DESCRIPTION

In the following description, specific details are set forth to provide illustrative examples of the systems and techniques described herein. The presented concepts may be practiced without some, or all, of these specific details. In other instances, well known process operations have not been described in detail to avoid unnecessarily obscuring the described concepts. While some concepts will be described with the specific examples, it will be understood that these examples are not intended to be limiting.

Some implementations of the disclosed systems, apparatus, methods and computer program products are configured for implementing commercial asset tracking systems. The commercial asset tracking systems described herein allow for commercial assets to be tracked by interfacing with user devices and for information related to the assets to be provided via the user devices, according to the techniques described herein. In various embodiments, commercial assets may include, for example, commercial equipment. Such commercial equipment may include heavy equipment (e.g., heavy machinery), tools, light equipment (e.g., handheld equipment), and/or any other such asset that may be helpful for carrying out a project.

Currently, various commercial equipment are tracked by data manually entered by workers, with tracker power and asset information provided through On-Board Diagnostics II (OBD II) ports for vehicles. Accordingly, tracking of commercial equipment is arduous and labor intensive. Tracking via OBD II ports is limited to equipment that includes such ports, such as vehicles. The options for tracking commercial equipment are, thus, limited in both functionality and options. Furthermore, current commercial equipment tracking is limited by specific vendor. That is, each vendor or tracking service provider may provide tracking through their specific implementations and cross compatibility is unavailable.

Current tracking equipment tends to lack movement state detection components due to the costs of such components. Even if such tracking equipment provides location data, there is no determination as to whether the tracker is moving. Rather, the location data is simply directed to location. However, for commercial equipment, whether equipment is moving (e.g., being shipped) is often a critical piece of information.

The systems and techniques described herein provide for a state machine for commercial equipment trackers for detecting motion events. Specifically, motion events such as the current motion state of the commercial equipment trackers may be determined. The systems and techniques described herein allow for detection of motion events of commercial equipment (e.g., construction equipment, vehicles, and/or other such equipment) through data from one or more of Global Navigation Satellite Systems (GNSS), radio systems (e.g. LTE, Wi-Fi, Bluetooth Low Energy, etc.), inertial measurement units (e.g., accelerometers or IMUs), and/or other such systems. A plurality of the same or different systems may be utilized simultaneously. Thus, for example, a plurality of radio systems may be utilized simultaneously (e.g. LTE, Wi-Fi, and/or BLE capabilities may be utilized simultaneously) for motion state determination by radio data.

In various embodiments, the systems and techniques provide a state machine algorithm that utilizes one or more of GNSS, radio, IMU, and/or other data to allow for determination of transition between states. Such states may correspond to motion states. Thus, the systems and techniques allow for accurate determination of motion events of commercial equipment trackers while rejecting both false positive and false negative events.

The commercial equipment tracker described herein provides a portable digital tracking tag that is configured to be affixed to commercial equipment. The commercial equipment tracker may include sensors, processors, and memories to allow the tracker to obtain location data, information, usage, conditions, movement states, and history for the equipment. The tracker may include one or more communications modules that may provide data packets to a mobile device, such as a user's mobile device. The data packets may, for example, provide a unique identifier associated with the tracker or equipment, indicate the location of the tracker, and/or indicate the status of the commercial equipment. An application on the mobile device may then combine the data received from the tracker with data determined by the mobile device, such as the location information, time, and status data associated with the commercial equipment and relay the data to a server device.

It is appreciated that, for the purposes of this disclosure, when an element includes a plurality of similar elements distinguished by a letter or follow-on numeral following the ordinal indicator (e.g., “116A” and “116B”, “116-1” and “116-2”, or “116A-1” and “116A-2”) and reference is made to only the ordinal indicator itself (e.g., “116”), such a reference is applicable to all the similar elements.

### Tracking System

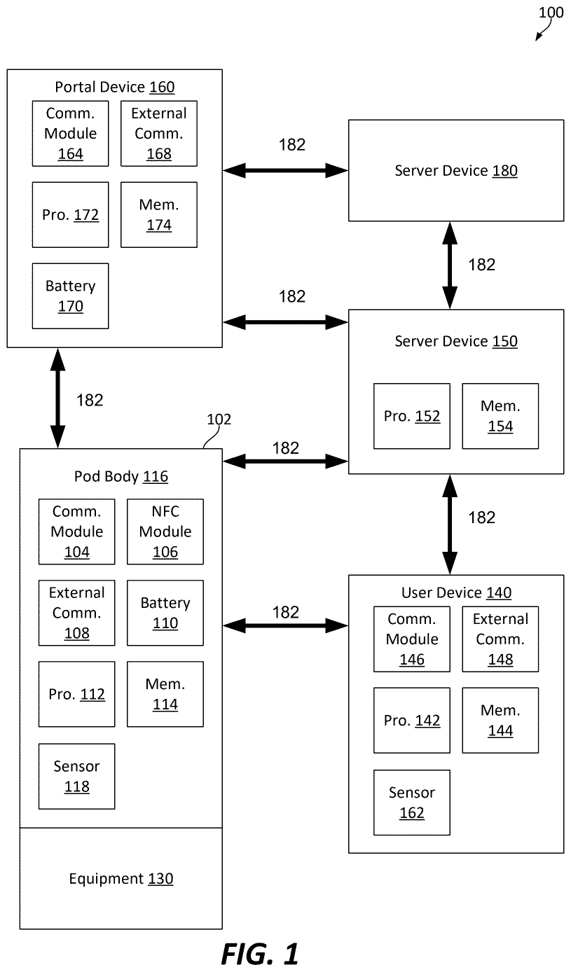

FIG. 1 illustrates a block diagram of an example system, in accordance with certain embodiments. FIG. 1 illustrates system 100 configured to track the location, status, and conditions of commercial equipment, as well as for scheduling usage of the commercial equipment.

System 100 includes tracking pod 102 coupled to commercial equipment 130, user device 140, server device 150, portal device 160, and server device 180. Various portions of system 100 may be communicatively coupled via any wired and/or wireless data connection, such as via communications channel 182. Communications channels 182 may include, for example, any one or more of a wired Ethernet connection or a wireless connection such as Bluetooth, Near-Field Communication (NFC), WiFi, 3G, 4G, 5G, or another such connection that allows for data to be transmitted. In various embodiments, the various components of the systems described herein may utilize one, some, or all such data connections to communicate and/or receive the various data described herein.

Tracking pod 102 includes communications module 104, NFC module 106, external communications module 108, battery 110, processor 112, memory 114, and sensor 118. Each of communications module 104, NFC module 106, external communications module 108, battery 110, processor 112, and memory 114 may be disposed within pod body 116. It is appreciated that, though such modules are shown in the singular for simplicity, tracking pod 102 may include one or a plurality of each module. For example, tracking pod 102 may include a plurality of external communications module 108, with one such module configured to communicate on the GNSS protocol and another such module configured to communicate via a protocol for tracking by radio towers.

Communications module 104 may be a short-ranged communications module that is configured to connect with a user device, such as portal device 160, to provide data to the user device. Thus, communications module 104 may be, for example, a module configured to communicate via Bluetooth®, Bluetooth Low Energy (BLE), ultra-wideband (UWB), and/or other such communications protocols that allow for devices to communicate data within a range of, for example, 150 meters or less or within a few miles (e.g., via LoRa). In various embodiments, portal device 160 may be a dedicated tracking portal (e.g., configured to receive data from one or more tracking pods 102 and provide tracking data associated with tracking pods 102) and/or may be an electronic device such as a smartphone or wearable device that may function as a tracking portal as well as provide other user functionalities.

In various embodiments, communications module 104 may include one or a plurality of different modules to, for example, allow for communication between tracking pod 102 and other tracking pods as well as with portal device 160, via a plurality of different protocols. For example, communications module 104 may include a beacon module, such as a BLE beacon, that allows for portal device 160 to determine the proximity of tracking pod 102 to other tracking pods or portal device 160. Accordingly, such a beacon module may allow for other tracking pods or portal device 160 to find tracking pod 102 or detect when tracking pod 102 is within a close range (e.g., 150 meters or less) and provide an alert when tracking pod 102 is within such a range and/or has moved outside of such a range. Beacon module may also allow for determination of the approximate range that tracking pod 102 is away from portal device 160 or other tracking pods. Thus, such a beacon module, when detected by a plurality of other devices, may allow for triangulation and/or trilateration to determine the location of the beacon module and, thus, tracking pod 102. Such triangulation and/or trilateration may be performed between the devices themselves and/or may be performed by server device 150 utilizing data received from the various user devices.

In another embodiment, communications module 104 may include a UWB module that communicates through the UWB spectrum to allow for more precise locating of tracking pod 102 by portal device 160. Thus, UWB module allows for accurate location in three-dimensions by portal device 160. In various embodiments, UWB module may provide a shorter range than a BLE beacon, such as a range of 75 meters or less. Accordingly, both a BLE beacon and a UWB module may be utilized in various embodiments of communications module 104.

Such a UWB module may allow for tracking and/or location of equipment within a large jobsite. Certain jobsites may be, for example, up to several square kilometers in size. Equipment may be moved around the jobsite. Thus, for example, a fork lift may be charged in one location and utilized in another location on the jobsite. The UWB module may allow for tracking of the equipment within various portions of the jobsite, simplifying receipt of information, scheduling, and obtaining location details.

Thus, for example, portal device 160 may provide a request for precise tracking of tracking pod 102. The precise tracking may be via the UWB module. Upon receipt of such a request, tracking pod 102 may activate the UWB module and the UWB module may communicate with portal device 160. Precise tracking of tracking pod 102 by portal device 160 may then be accomplished via data from the UWB module.

NFC module 106 may be a module that allows for tracking pod 102 to communicate with portal device 160 or another tracking pod via Near-Field communication protocols. In various embodiments, NFC module 106 may allow for tracking pod 102 to easily pair with the other tracking pod or portal device 160. Thus, for example, tracking pod 102 may simply be disposed proximate (e.g., within a foot) to the other tracking pod or to portal device 160 and pairing data may be communicated between tracking pod 102 and the other device (e.g., data directed to the identity of one or more such devices, identity of the item that tracking pod 102 is associated with, such as the equipment to be tracked, and/or communication information, such as Bluetooth pairing information). Pairing of tracking pod 102 to the other tracking pod or to portal device 160 allows for data to be communicated between the devices. NFC module 106 may also allow for tracking pod 102 to communicate data associated with commercial equipment 130 (e.g., data directed to the status of commercial equipment 130) so that commercial equipment 130 may communicate data to tracking pod 102 and/or allow tracking pod 102 to interface with commercial equipment 130 to determine the status, condition, and/or usage of commercial equipment 130.

In certain embodiments, communication module 104 and/or NFC module 106 may, in certain embodiments, allow for portal device 160 to identify commercial equipment 130 by communicatively coupling with NFC module 106. Once communicatively coupled, communication module 104 and/or NFC module 106 may provide information, usage, conditions, history, and/or other data that is associated with commercial equipment 130.

External communications module 108 may be one or more communications modules configured to interface with one or more external devices. Such external devices may include, for example, a GNSS/global positioning system (GPS) satellite, a cellular tower, or another such device configured to provide data to tracking pod 102.

Various such external communications modules 108 may thus be configured to communicate via the communications protocols of such devices (e.g., via the GNSS, radio, cellular tower, and/or other such protocols). Such an external device may, thus, allow for data to be communicated between tracking pod 102 and server device 150 and/or server device 180 without data being communicated to portal device 160 (e.g., by providing location data for cellular towers to determine the location of tracking pod 102 and provide the determined location to server device 150 and/or server device 180). Alternatively or additionally, external device 160 may provide location data to tracking pod 102 (e.g., GPS data).

Location information may also be deduced from the signal strength of data received by communication module 164 from other devices and/or portal device 160 or another such device may deduce the location of tracking pod 102 from the signal strength of data provided by tracking pod 102. Thus, for example, external device 160 (which may be a user device or a tracking portal configured to communicate with a server device), would utilize the unique identifier of tracking pod 102 (which may be of a BLE format) received by external device 160 and the determined location of external device 160. Utilizing the determined location of external device 160, external device 160 may then utilize the unique identifier of tracking pod 102 and read the Received Signal Strength Indicator (RSSI) from the BLE packet of the unique identifier to determine the strength of the BLE signal from tracking pod 102. Based on the RSSI, external device 160 may estimate the distance of tracking pod 102 away from external device 160.

Additionally, the location data of the external device 160 may also be utilized to determine the motion state of the tracking pod 102.

Accordingly, tracking pod 102 may communicate with external device 160 via communications channel 182. External device 160 may also provide firmware updates or obtain status data automatically from various tracking pods and relay such data to server device 150 and/or server device 180 so that such data may be processed and, if necessary, notifications may be provided to a user (e.g., when certain equipment has moved outside of a zone where the equipment is intended to be within).

Memory 114 may be any type of memory device configured to store data and/or instructions. Memory 114 may be, for example, a harddrive, a solid state device, and/or random access memory (RAM) and may include transitory or non-transitory computer-readable media. Memory 114 may be configured to store instructions for performing the techniques described herein, configured to store commercial equipment data (e.g., data associated with the status of commercial equipment 130), and/or configured to store other such data.

Processor 112 may be a single or multi-core processor. As described herein, processor 112 may be configured to perform various operations as described herein.

Accordingly, for example, processor 112 may cause data to be communicated from tracking pod 102 to portal device 160 for tracking of commercial equipment 130 or may utilize data received to determine a motion state of tracking pod 102. Processor 112 may be any type of single or multi-core processor that allows for electronic data processing. It is appreciated that processor 112 may perform the techniques described herein utilizing one or more databases, modules, and/or other system components as described herein. Accordingly, processor 112 may perform the techniques described herein while calling upon data stored within memory 114 and/or utilizing the data of one or more modules described herein.

Battery 110 may be a battery configured to store electrical power for powering tracking pod 102. Electrical power from battery 110 may be provided to the various components of tracking pod 102 through various electrical circuits. In various embodiments, a state of charge of battery 110 may be determined through various circuit configurations described herein.

Sensor 118 may be, for example, one or more temperature sensors, accelerometers, gyroscopes, strain detectors (e.g., strain gauges), piezoelectric sensors, magnetic sensors, and/or other such sensors. For example, sensor 118 may include an inertial measurement unit (IMU) that is configured to measure and provide data indicating the specific accelerations experienced by tracking pod 102, the angular rate of change of tracking pod 102, and/or the orientation of tracking pod 102. In various embodiments, such an IMU of sensor 108 may include one or more accelerometers, gyroscopes, and/or magnetometers. Variously, sensor 118 may be fully contained within pod body 116 and/or may interface (e.g., contact) portions of commercial equipment 130.

In various embodiments, sensor 118 may be configured to, for example, determine ambient environmental conditions and/or movement of tracking pod 102 that is indicative of movement of commercial equipment 130. Thus, for example, sensor 118 may be configured to determine the acceleration, jerk, velocity, and/or vibrations. Sensor 118 may be configured to determine the magnitude and/or frequency of the movement. Sensor data from sensor 118 may be provided to, for example, processor 112 of tracking pod 102.

Processor 112 may accordingly utilize the sensor data to determine various aspects of commercial equipment 130. For example, processor 112 may determine that commercial equipment 130 is being operated and determine the additional operation cycles (e.g., from sensor data indicating the movement or vibration of commercial equipment 130) imparted to commercial equipment 130. Such data may allow for tracking pod 102 to update the number of operation cycles that commercial equipment 130 has been subjected to. Processor 112 may also determine from, for example, acceleration or velocity data the movement of commercial equipment 130 (e.g., from a location where commercial equipment 130 is typically housed within, such as a hanger or a drawer). Such a change in location may be communicated to portal device 160 to provide more accurate information as to the location of commercial equipment 130. Processor 112 may also receive data from various communications modules 104 and/or sensors 118 to determine a movement state of tracking pod 102 and/or other associated tracking pods. For example, processor 112 may receive GNSS data, radio data, IMU data, and/or other such data and determine a movement state of tracking pod 102 and/or other associated tracking pods, according to the techniques described herein. Such techniques described herein may provide a flexible, configurable, and adaptable (e.g., based on system and/or memory constraints) technique for motion detection. For example, while such a technique may provide for the most accurate results when all such data is available and processed, such techniques may also utilize only one, some, or all of GNSS data, radio data, IMU data, and/or other data due to data availability and/or power consumption constraints. For example, if power consumption is not a concern, then all such communications modules 104 and/or sensors 118 (e.g., GNSS, radio, and IMU) may be operated at a high sample frequency. However, the system and techniques described herein may also allow for a high level of accuracy in terms of motion detection even when operating in a power conservation mode where only a portion of communications modules 104 and/or sensors 118 are operated and/or available.

In certain embodiments, input may be provided to tracking pod 102 (e.g., to processor 112 and stored within memory 114) of the type or category of equipment of commercial equipment 130. Based on the type or category of equipment, sensor 118 may be configured to track various aspects of commercial equipment 130. Thus, for example, the user may provide, via portal device 160, that commercial equipment 130 is a tool with a limited amount of cycle life. Accordingly, sensor 118 may be configured to determine movement and/or acceleration of commercial equipment 130 indicative of a load cycle for the tool and, based on the amount of load cycles detected by sensor 118, the status of commercial equipment 130 may be updated. Thus, in various embodiments, data directed to the status of commercial equipment 130 may be stored within memory 114, may be provided to portal device 160 and stored within memory 174 of portal device 160 and/or communicated to server device 150 and/or server device 180 for storage. Based on the data from sensor 118, such stored data may be accordingly updated and, thus the status of commercial equipment 130 may be updated.

In another such embodiment, data from sensor 118 may indicate when commercial equipment 130 is being operated and, based on such a determination, the operational hours of commercial equipment 130 may be tracked. In a further such embodiment, data from sensor 118 may indicate that commercial equipment 130 is being utilized or located in the area of operation of various operators and, accordingly, the operators that have used the specific commercial equipment 130 may also be updated. Furthermore embodiments may, for example, detect the environmental conditions, such as temperature and pressure (e.g., via temperature or pressure sensors), that commercial equipment 130 has been subjected to. Thus, if commercial equipment 130 has been subjected to temperatures beyond its operating envelope, the status of commercial equipment 130 may be changed to “non-operational.” Pod body 116 may be, for example, any type of external body that can be configured to contain the components of tracking pod 102 and allow for tracking pod 102 to be held by a user. Thus, pod body 116 may be a case for the components of tracking pod 102 that is made from plastic, composites, metal, rubber, and/or other materials.

Pod body 116 may be configured to be disposed within housing 120. Accordingly, housing 120 may include a cavity that may be shaped to receive pod body 116. Pod body 116 may, in certain embodiments, be configured to be snugly held within the cavity of housing 120. Housing 120 may be a housing made from plastic, composites, metal, rubber, and/or other materials and may provide a durable outer covering for tracking pod 102 to prevent damage to tracking pod 102 (e.g., from operation of various commercial equipment around tracking pod 102).

Commercial equipment 130 may be any type of commercial equipment, including handheld equipment such as tools and bits, heavy equipment such as vehicles, raw materials, and/or other such commercial equipment. In various embodiments, commercial equipment 130 may be shared equipment, such as equipment shared within a company or firm, or rental equipment. Commercial equipment 130 may be shared between different jobs and/or sites and may be moved between those jobs and/or sites depending on project need.

Portal device 160 may be an electronic device configured to receive data from tracking pod 102. In various embodiments, portal device 160 may be an electronic device specifically configured to receive data from tracking pod 102 (e.g., an electronic device configured to receive tracking data from tracking pod 102) and/or may be a user device, desktop computing devices, portable computing devices (e.g., laptops, tablets, smartphones, and/or other electronic devices), wearable devices, and/or other such electronic devices. Portal device 160 may be configured to utilize tracking pod 102 to track the location and/or status of commercial equipment 130.

Portal device 160 may include communications module 164, external communications module 168, battery 170, processor 172, and memory 174.

Communications module 164 may be a short-ranged communications module, similar to communications module 104, configured to connect with an associated device, such as tracking pod 102, and communicate (e.g., send or receive) data from such devices.

External communications module 168 may be a communication module configured to interface with one or more external devices through long range communications. Such external devices may include, for example, a global positioning system (GPS) (a.k.a.

GNSS) satellite, a cellular tower, or another such device configured to provide or receive data from portal device 160. External communications module 168 may be configured to allow for portal device 160 to communicate with other devices, such as server device 150 and/or server device 180, via communications channel 182.

Processor 172 and memory 174 may be similar to other processor and memory described herein, respectively. Thus, memory 174 may store instructions and processor 172 may be configured to perform techniques described herein based on instructions stored within memory 174. Battery 170 may be a battery configured to store energy to operate portal device 160.

Data, such as tracking data, may be communicated between tracking pod 102 and portal device 160 via communications channel 182. In various embodiments, a plurality of portal devices may be communicatively coupled to tracking pod 102 and each portal device may be configured to track the location of tracking pod 102 if the portal device is within range of tracking pod 102.

In various embodiments, portal device 160 may be configured to scan tracking pod 102 and determine details of the equipment that tracking pod 102 is coupled to. For example, portal device 160 may scan tracking pod 102 to determine the maintenance that is due to be performed on equipment 130. Once maintenance has been performed, portal device 160 may also scan tracking pod 102 to indicate that the maintenance has been performed. Such a technique may reduce paper trail requirements.

User device 140 may be an electronic device configured to receive data from and communicate data to tracking pod 102. User device 140 may include communications module 146, external communications module 148, processor 142, memory 144, and sensor 162.

Processor 142 and memory 144 may be similar to other processor and memory described herein, respectively. Thus, memory 144 may store instructions and processor 142 may be configured to perform techniques described herein based on instructions stored within memory 144.

Communications module 146 may be a short-ranged communications module, similar to communications module 104, configured to connect with an associated device, such as tracking pod 102, and communicate (e.g., send or receive) data from such devices.

External communications module 148 may be a communication module configured to interface with one or more external devices, such as GPS/GNSS satellites, radio towers, and/or other such external devices, through long range communications. External communications module 148 may also be configured to allow for user device 140 to communicate with other devices, such as server device 150 and/or server device 180, via communications channel 182.

Sensor 162 may include one or more sensors for determining conditions associated with user device 140. Thus, for example, sensor 162 may include one or more accelerometers, gyroscopes, magnetometers, IMUs, and/or other such devices for determining location and/or movement of user device 140.

Server device 150 and/or server device 180 may be a server system that operates as one computing device or a plurality of devices. Each of server device 150 and/or server device 180 may be, for example, an application server, a database server, and/or a client system such as a laptop, desktop, smartphone, tablet, wearable device, and/or any other device or service described herein.

Server device 150 may include processor 152 and memory 154 and server device 180 may include similar componentry. Memory 154 may include one or more databases that may provide data to portal device 160 via communications channel 182 (e.g., in response to requests for data from portal device 160) for server device 150 and via communications channel 182 for server device 180. Processor 152 may be configured to perform operations of server device 150, as described herein. In certain embodiments, server device 150 and server device 180 may communicate data via communications channel 182. Such communications may provide for implementation of certain portions of the techniques described herein.

Additionally or alternatively, server device 150 may receive data (e.g., location data) from tracking pod 102 and/or provide data (e.g., instructions) to tracking pod 102 via communications channel 182. Server device 150 may also provide data to portal device 160 to, for example, allow for scheduling of commercial equipment 130 (e.g., to be used by various users of commercial equipment 130, such as between different jobsites). In certain such embodiments, communications channel 182 may be a communications channel providing data through, for example, a cellular network.

### Network System

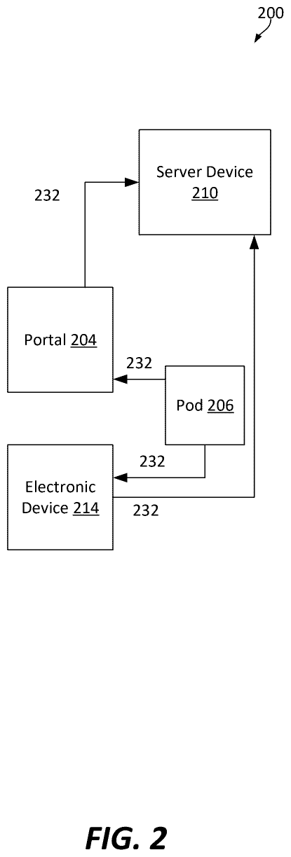

FIG. 2 illustrates another block diagram of an example system, in accordance with certain embodiments. FIG. 2 illustrates system 200 with portal 204, tracking pod 206, electronic device 214, and server device 210. It is appreciated that though FIG. 2 illustrates system 200 with singular portal 204, tracking pod 206, electronic device 214, and server device 210, other embodiments may include a plurality of such devices and/or may not include one or more such devices.

Tracking pod 206 may be similar to tracking pod 102 described in 102. Portal 204 may be similar to portal device 160 and may be a portal configured to receive data, such as location or tracking data, from various devices or tracking pods described herein.

Portal 204 may be configured to receive such data from tracking pod 206 and provide such data, or portions thereof, to server device 210.

Electronic device 214 may be a user device or other electronic device and may, for example, be similar to user device 140. In certain embodiments, electronic device 214 may include apps or computer programs that are associated with tracking provided by tracking pod 206 and/or system 200. That is, electronic device 214 may include one or more apps or computer programs that provide or receive tracking data, provide or receive location data, and/or provide or receive movement state data.

Server device 210 may, in certain embodiments, be similar to server device 150 and/or server device 180. Server device 210 may be configured to receive and communicate data to other portions of system 200, including various pods, portals, and/or electronic devices (e.g., tracking pod 206, electronic device 214, and/or portal 204) as well as other devices.

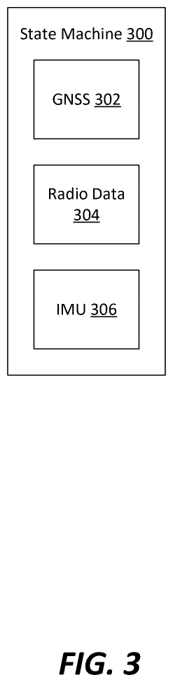

FIG. 3 illustrates a block diagram of a state machine, in accordance with certain embodiments. FIG. 3 illustrates state machine 300. State machine 300 of FIG. 3 utilizes data including GNSS data 302, radio data 304, and IMU data 306.

Variously, GNSS data 302, radio data 304, and IMU data 306 may be utilized to determine a state of movement. Thus, state machine 300 may combine GNSS data 302, radio data 304, and/or IMU data 306 to determine a movement state of an associated tracking pod. It is appreciated that state machine 300 may combine GNSS data 302, radio data 304, and/or IMU data 306 from any number of associated sources. Thus, such data may be determined by portions of the specific tracking pod and/or provided from other sources.

State machine 300 may utilize one, some, or all of GNSS data 302, radio data 304, IMU data 306, and/or other such data. Accordingly, state machine 300 is flexible and configurable based on system constraints (e.g., data constraints). State machine 300 may provide the highest accuracy when utilizing all available data (e.g., all of GNSS data 302, radio data 304, and IMU data 306). However, state machine 300 is still capable of accurate operation as long as at least one of the GNSS data 302, radio data 304, or IMU data 306 is provided.

Accordingly, state machine 300 may be operated on a spectrum of power efficiencies, depending on power consumption desired and/or data available. For example, if power consumption is not a concern, then all of GNSS data 302, radio data 304, and/or IMU data 306 may be sampled at a high frequency. However, motion detection may be determined even when operating in a power conservation mode (e.g., with low sampling frequencies from one or more of GNSS data 302, radio data 304, and IMU data 306).

### State Machine Operation Techniques

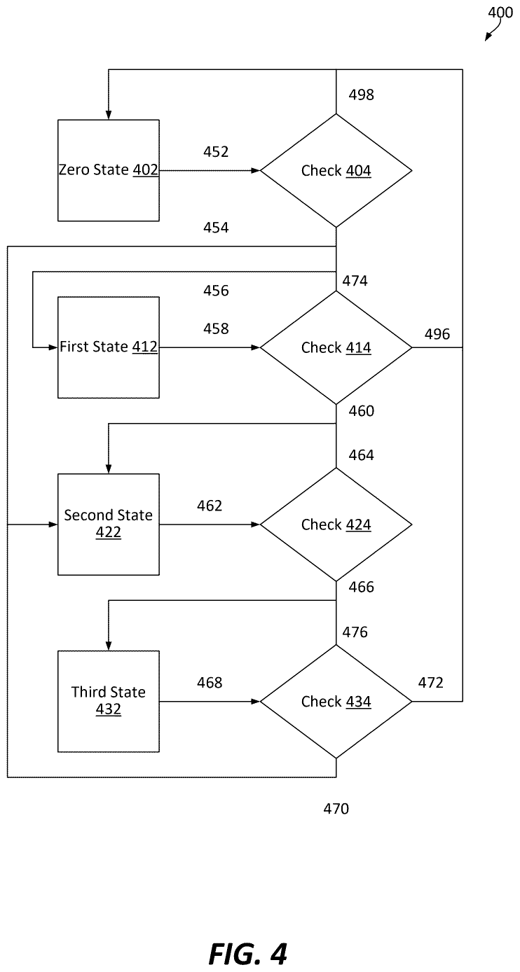

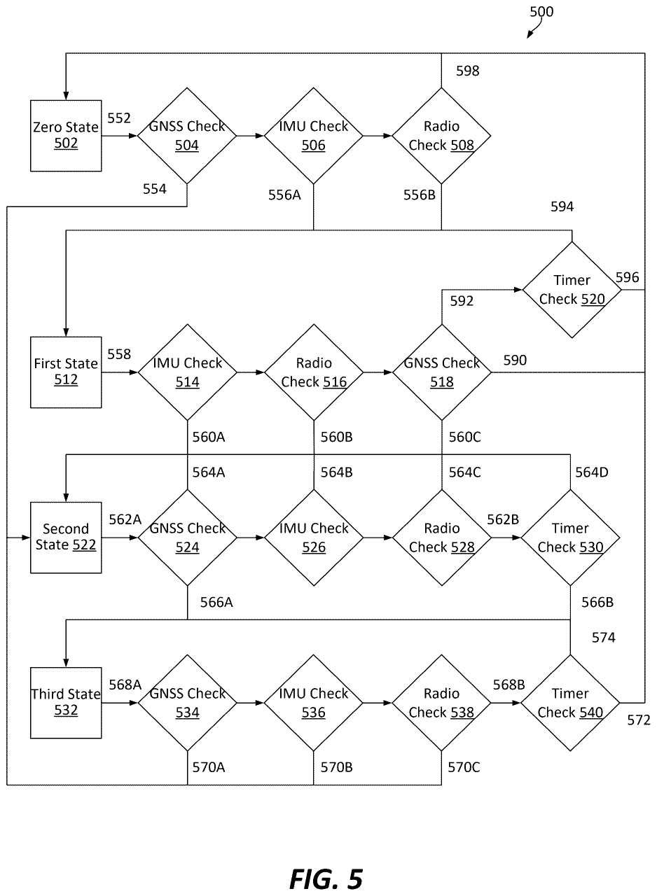

FIGS. 4 and 5 are flowcharts illustrating examples of operating a commercial equipment tracking state machine, in accordance with certain embodiments. FIG. 4 illustrates technique 400 while FIG. 5 illustrates technique 500. Both technique 400 and technique 500 are directed to determining movement states of tracking pods. In certain embodiments, technique 400 and/or technique 500 may be performed with one or more controllers (e.g., memory and processor) of a commercial tracking pod described herein.

FIG. 4 illustrates technique 400. In 402 of technique 400, the tracking pod may be determined to be in a zero state. The zero state may be a motionless state or a state where movement of the tracking pod is determined to be below a threshold (e.g., below a speed, velocity, or other such movement threshold). In various embodiments, the various motion states determined in technique 400 and technique 500 of FIGS. 4 and 5, respectively, may be for a tracking pod of interest. Such a determination may be performed by a controller of the tracking pod, by a controller of another electronic device, or by a combination of the controller of the tracking pod in question and another electronic device.

Technique 400 may proceed from a determination of zero state 402 to check 404, which may be a check of the motion state of the tracking pod, based on trigger 452. Trigger 452 may cause check 404 to be performed due to the elapsing of a threshold amount of time, receipt of data from one or more data sources (e.g., from GNSS data, IMU data, and/or radio data), and/or through another such trigger.

Check 404 may be a check by the controller performing technique 400 to determine whether data has been received that may indicate an updated movement state. Such a check may utilize one or more of GNSS data, IMU data, and/or radio data. Such a check may determine whether any of GNSS data, IMU data, and/or radio data received (e.g., within a threshold period of time, such as within the last second, last five seconds, last thirty seconds, or another such threshold) indicates movement of the tracking pod.

In various embodiments, check 404 may result in analysis of the received data (e.g., GNSS data, IMU data, and/or radio data) to determine whether the data indicates movement. Such data may indicate movement of the tracking pod by, for example, GNSS data that indicates a change in position, IMU data that indicates acceleration (whether linear or angular), radio data that indicates a change in signal search to various fixed position radio towers, and/or other such techniques. Conversely, a determination that the tracking pod is not moving may be determined based on a lack of updated data and/or GNSS data that indicates no change in position, IMU data that indicates a lack of acceleration (whether linear or angular), radio data that indicates no change in signal search to various fixed position radio towers, and/or other such techniques.

Check 404 may result in determination 454, determination 456, or determination 498. Determination 454 may be a determination that movement has been detected within the data. Determination 456 may be a determination that the data may indicate possible motion, but may only indicate movement to a confidence level lower then a threshold level (e.g., may indicate that the tracking pod may be moving, but may also be possibly indicating a false positive). In various embodiments, check 404 may determine that movement detected by certain types of data (e.g., GNSS data) indicates movement and thus result in determination 454 while movement detected by other types of data (e.g., IMU data that is not sustained over a threshold period of time) may indicate possible movement and thus result in determination 456. Determination 498 may be a determination that no movement has been detected within the data.

Thus, determination 454 may result in a determination of second state 422.

Second state 422 correlates to determined movement of the tracking pod.

Determination 456 may result in a determination of first state 412. First state 412 indicates a determination of possible movement of the tracking pod. Determination 498 may result in a determination of zero state 402, which may be no movement.

Meanwhile, third state 432 may correlate to a determination of possible motionless.

Thus, third state 432 may be utilized as a motion state to determine that a tracking pod that was previously determined to be moving has ceased moving, but with a lower confidence level and, thus, third state 432 may allow for avoidance of a false negative determination of lack of movement.

Regardless of the motion state determined, periodic checks may be performed to confirm a current state or determine a new state of the tracking pod. Thus, for example, determination 458 may cause the controller performing technique 400 to determine whether the tracking pod is actually in motion (second state 422) or motionless (zero state 402). Determination 462 may cause the controller performing technique 400 to determine whether the tracking pod is actually in motion (second state 422) or may possibly be motionless (third state 432). Similarly, determination 468 may cause the controller performing technique 400 to determine whether the tracking pod is actually in motion (second state 422), possibly motionless (third state 432), or motionless (zero state 402). Each of check 414, check 424, and/or check 434 may utilize one or more of GNSS data, IMU data, and/or radio data to determine movement states Of note, the state machine of technique 400 provides for determination of four different states (zero state 402, first state 412, second state 422, and third state 432) and while the determined motion state may change from one state to another, technique 400 may be configured so that not all states may immediately transition to all other states. Such a configuration may prevent false positives or false negatives. Instead, certain transitions between states may require a plurality of determination cycles (e.g., checks) to provide for such transitions. For example, the state machine of technique 400 may allow for a determined zero state 402 to transition to first state 412 and second state 422, but not directly transition to third state 432. Instead, zero state 402 may first transition to second state 422 before transitioning to third state 432. Similarly, first state 412 may directly transition to zero state 402 or second state 422. Second state 422 may directly transition to third state 432. Third state 432 may directly transition to zero state 402 or second state 422. All states may remain in the determined state.

Check 414 may result in determination 460, determination 474, or determination 496. Determination 460 may be a determination that the tracking pod is in second state 422. Determination 460 may be made based on further received data that further indicates movement. Determination 496 may be a determination that the tracking pod is in zero state 402. Such a determination may be made based on a lack of received updated data or received data that indicates lack of movement. Determination 474 may be a continued determination of first state 412 for the tracking pod, such as a lack of updated data, but being within a threshold period of time since the last update.

Of note, various thresholds (e.g., threshold periods of time, threshold acceleration, threshold velocity, and/or other thresholds) are referenced in this disclosure. Each step may include its own unique threshold. That is, each step may have a threshold with a unique value or a value that is shared with one or more other steps.

Similarly, check 424 may result in determination 464 or determination 466. Determination 464 may be a determination that the tracking pod continues to be in second state 422. Such a determination may be from further updated data received and/or based on a determination that a threshold period of time has not elapsed since data was last received. Determination 466 may be a determination that the tracking pod is in third state 432, possibly motionless. Such a determination may be based on certain data indicating cessation of motion and/or a determination that a threshold period of time has elapsed since updated data was last received. In certain embodiments, second state 422 may automatically proceed to third state 432 via determination 466. Such a technique may allow for quicker determination of motion state changes. In certain such embodiments, check 424 may be a short duration (e.g., less than 10 seconds, less than 5 seconds, or less than 1 second) determinations that the determined state is second state 422 and that the determined state should proceed to third state 432. In other embodiments, there may not be check 424 at all and instead second state 422 automatically proceeds to third state 432 without any checks.

Check 434 may result in determination 470, determination 472, or determination 476. Determination 470 may be a determination that the tracking pod is in second state 422. Determination 470 may be based on further received data that indicates movement. Determination 472 may be a determination that the tracking pod is in zero state 402. Such a determination may be based on a lack of updated data received, during a threshold period of time, that indicates movement. Determination 476 may be a continued determination of third state 432 for the tracking pod. Such a determination may be based on a determination that a threshold period of time has not elapsed since data was last received.

Variously, the techniques described herein may provide outputs when the motion state is determined to be entering certain states. Thus, for example, when the state is determined to be transitioning into one or more of zero state 402, first state 412, second state 422, and/or third state 432, according to one or more of the determinations, an output may be provided to a user device indicating the transition into such motion states. For example, in a certain embodiment, one or more of determination 454, determination 460, and/or determination 470 may result in an output (e.g., data output) that causes an electronic device or server device to provide an indication (e.g., via audio or on a GUI) that the motion state of a tracking pod is second state 422. Additionally or alternatively, one or more of determination 496 and/or determination 472 may result in an output that causes the electronic device or server device to provide an indication that the motion state of the tracking pod is zero state 402.

FIG. 5 illustrates technique 500. Technique 500 provides for the determination of a state machine. The state machine may provide determined motion states for one or more tracking pods. Thus, the state machine may be associated with one or a plurality of tracking pods and the determination of the state of the state machine may apply to the state of one, some, or all of the associated tracking pods. In certain embodiments, when technique 500 determines or updates a state of the state machine, such data may be provided to an associated device, such as a server device, a portal device, or a user device, which may then communicate the determined state to a user.

In certain embodiments, the state machine may be determined to be one of a plurality of different states, such as four different states. For example, the state machine may be determined to be in zero state 502 (motionless), first state 512 (possibly in motion), second state 522 (in motion), or third state 532 (possibly motionless). Zero state 502, first state 512, second state 522, and third state 532 may correspond to zero state 402, first state 412, second state 422, and third state 432 of technique 400.

The state of the state machine may be reevaluated based on one or more conditions. For example, the state may be reevaluated if updated data or certain types of updated data are received. Additionally or alternatively, the state may be reevaluated at a regular time interval (e.g., every 1 second, 5 seconds, 10 seconds, 30 seconds, and/or another such time interval). Certain motion states may allow for a transition to a different determined motion state, but the state machine may be configured so that some motion states may not directly transition to other motion states.

In technique 500, the state machine may start at zero state 502. Trigger 552, may be a trigger based on one or more conditions described herein (e.g., receipt of additional data or passage of an interval of time) or may be a trigger based on another specific condition (e.g., a user request). For example, trigger 552 may correspond to when GNSS data is available. As such, zero state 502, in such embodiments, may not be reevaluated unless GNSS data is received to, for example, avoid false positives that may result from jostling or other movement of a tracking pod of the state machine where the tracking pod is not actually moved.

In GNSS check 504, GNSS data is evaluated and/or an estimated speed from the GNSS data (e.g., using a Kalman Filter) is determined. This estimated speed may be compared to a speed threshold. If the estimated speed exceeds the speed threshold, determination 554 may place the state machine in second state 522 (in motion).

If the estimated speed is below the speed threshold or if there is a lack of updated GNSS data (e.g., for evaluations based on receipt of non-GNSS data and/or based on time intervals), the state machine may evaluate IMU data via IMU check 506. Thus, the IMU data may be sampled and evaluated directly, or an IMU may provide indications (e.g., data that includes alerts for exceeding certain acceleration threshold) or data (e.g., acceleration data) based on one or more acceleration thresholds being exceeded. If potential motion is determined from data provided by the IMU (e.g., acceleration exceeding a threshold or acceleration in a certain direction where there is no corresponding deceleration, indicating that the state machine is in constant motion and/or the motion is not back and forth movement), determination 556A may place the state machine in first state 512 (possibly in motion).

If IMU data does not register motion, if IMU data received is inconclusive about motion (e.g., may indicate acceleration in a variety of different directions), or if there is no IMU data available, technique 500 may proceed to determine if radio data is available in radio check 508. Radio check 508 may, for example, determine whether LTE or other signal data is available and determine whether the signal strength (and, thus, distance) with a radio tower (e.g., the closest cell tower) has changed past a threshold amount. If signal strength and/or determined distance has changed past the threshold amount determination 556B may place the state machine in first state 512. Otherwise, determination 598 may determine that the state machine remains in zero state 502.

If the state machine is in first state 512, trigger 558 may cause reevaluation of data to determine whether the determined state of the state machine should be updated. Trigger 558 may be any trigger condition described herein. Based on trigger 558, the state machine may check IMU data (in 514), radio data (in 516), and/or GNSS data (in 518). While in first state 512, such checks may occur in any order or may occur simultaneously for a plurality of different data types. If any such data check determines that the state machine is in motion, determination 560A-C may result in a determination that the state machine is in second state 522. Otherwise, if other data does not indicate motion and updated GNSS data received in GNSS check 518 does not allow for a determination of motion, determination 590 returns the state of the state machine to zero state 502.

If no updated GNSS data is received, determination 592 performs timer check 520. If no updated GNSS data is received, but a threshold period of time has not passed since receipt of the last GNSS data, determination 594 may continue to place the state machine in first state 512. Otherwise, if no GNSS data is received and a threshold period of time has passed since receipt of the last GNSS data, determination 596 may place the state machine in zero state 502.

If the state machine is in second state 522, trigger 562A may cause reevaluation of data to determine whether the determined state of the state machine should be updated. Trigger 562A may be any trigger condition described herein. Based on trigger 562A, the state machine may check GNSS data (in 524), IMU data (in 526), and/or radio data (in 528). While in second state 522, such checks may occur in any order or may occur simultaneously for a plurality of different data types.

Trigger 562A may, when performing data checks, perform timer check 530. Timer check 530 may reference a timer for an updated determination of the state of the state machine. Therefore, if updated GNSS data is not received based on GNSS check 524 (e.g., trigger 562A may cause a determination that no updated GNSS data has been received), and timer check 530 determines that a threshold amount of time has elapsed since the last determination of the state of the state machine (e.g., from one or more of GNSS data, IMU data, and/or radio data), the timer is deemed to be timed out by determination 566B and the state machine is placed in third state 532. Otherwise, if timer check 530 determines that the timer is not timed out, determination 564D may continue to place the state machine in second state 522.

If any such data check confirms that the state machine is in motion, according to the techniques described herein, determination 564A-C may place the state machine in second state 522 and the timer for timer check 530 is reset. Otherwise, if GNSS check 524 determines that speed or velocity calculated from GNSS data is below a speed threshold, the state machine may transition to third state 532 via determination 566A.

In third state 532, trigger 568A may cause reevaluation of data to determine whether the determined state of the state machine should be updated.

Trigger 568A may be any trigger condition described herein. Based on trigger 568A, the state machine may check GNSS data (in 534), IMU data (in 536), and/or radio data (in 538). While in third state 532, such checks may occur in any order or may occur simultaneously for a plurality of different data types. Trigger 562A may, when performing data checks, perform timer check 540, which may be a timer check similar to that of timer check 530 with the same or a different timer threshold.

If any such data check confirms that the state machine is in motion, according to the techniques described herein, determination 570A-C may place the state machine in second state 522. Otherwise, if the data checks do not result in a determination of motion upon timer check 540 timing out, determination 572 may place the state machine in zero state 502. If timer check 540 has not timed out (e.g., a threshold period of time has not yet passed), the state machine may continue in third state 532 via determination 574.

The techniques described herein may trigger a timestamp when a certain motion state (e.g., zero state 502, first state 512, second state 522, and/or third state 532) is determined or confirmed. Such a timestamp may be utilized for the timer checks described herein. It is appreciated that other time keeping techniques may be utilized.

For example, the timestamp may be started when the timer check has timed out (e.g., as part of determination 596, determination 564D, determination 566B, determination 574, and/or determination 572) additional or alternative to when a certain motion state is determined.

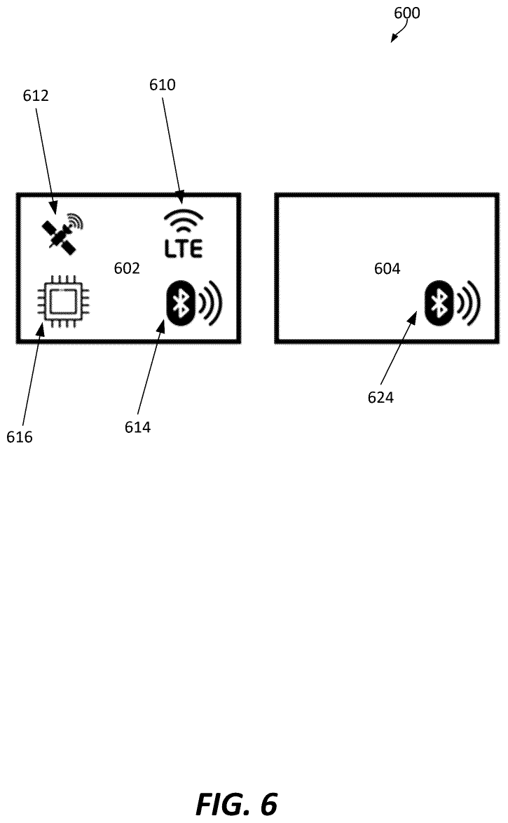

FIGS. 6, 7, 8A, 8B, and 8C illustrate examples of operating a commercial equipment tracking state machine, in accordance with certain embodiments. FIGS. 6, 7, 8A, 8B, and 8C illustrate various systems that include a plurality of devices. The plurality of devices may collectively allow for the determination of motion states of the system. The system and techniques described in FIGS. 6, 7, 8A, 8B, and 8C allow for determination of motion states of a plurality of different devices with inexpensive hardware, as a minimum of one device with a GNSS module, radio module, and/or IMU may provide for motion state determination for the plurality of devices.

For example, FIG. 6 illustrates system 600. System 600 includes device 602 and device 604. In certain embodiments, one or both of device 602 and device 604 may be commercial equipment tracking devices or may be devices that are otherwise coupled to commercial equipment.

Device 602 may include communication module 614, GNSS module 612, radio module 610, and IMU 616. Device 604 may include communication module 624.

Communication module 614 and communication module 624 may be short-ranged communication modules configured to operate via certain short ranged communication protocols described herein, such as Bluetooth protocols.

Device 602 may include modules configured to determine a motion state according to the techniques described herein, for device 602. Device 604 may be disposed proximate to device 602 and within range to communicate with device 602, via communication module 614 and communication module 624. As device 604 may be in communication with device 602, device 602 and/or device 604 may determine, based on continued communication between the devices, that device 604 is disposed proximate device 602. Accordingly, device 602 may communicate motion state data (e.g., determined motion states) to device 604 and/or to a server and indicate that such motion state data applies or is otherwise associated with device 604. For example, device 602 may communicate to the server that device 604 is also disposed proximate device 602 and, thus, while device 602 is detected to be proximate device 604 (e.g., based on communication between communication module 614 and communication module 624), the determined motion states of device 602 also applies to device 604.

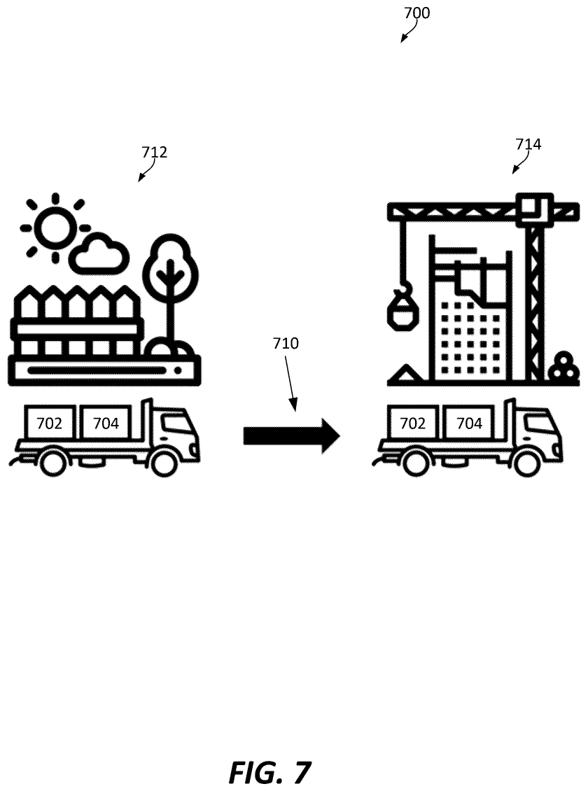

FIG. 7 illustrates system 700, which includes device 702 and device 704. Device 702 may be similar to device 602 and device 704 may be similar to device 604. As shown, device 702 and device 704 may be transported from location 712 to location 714 along route 710. While being transported along route 710, device 702 may determine various motion states (e.g., according to the techniques described herein) based on whether the transport is stopped, accelerating, decelerating, or moving. Accordingly, device 702 may communicate the determined motion state to a server device for tracking. As device 702 may determine that device 704 is disposed proximate to device 702, device 702 may communicate to a server device that device 704 is also in the same motion state as device 702. In other embodiments, device 702 may store the determined motion states and/or may communicate the determined motion state to device 704. Device 704 may then store or communicate the determined motion state (e.g., to a server device, which may be the same or different server device).

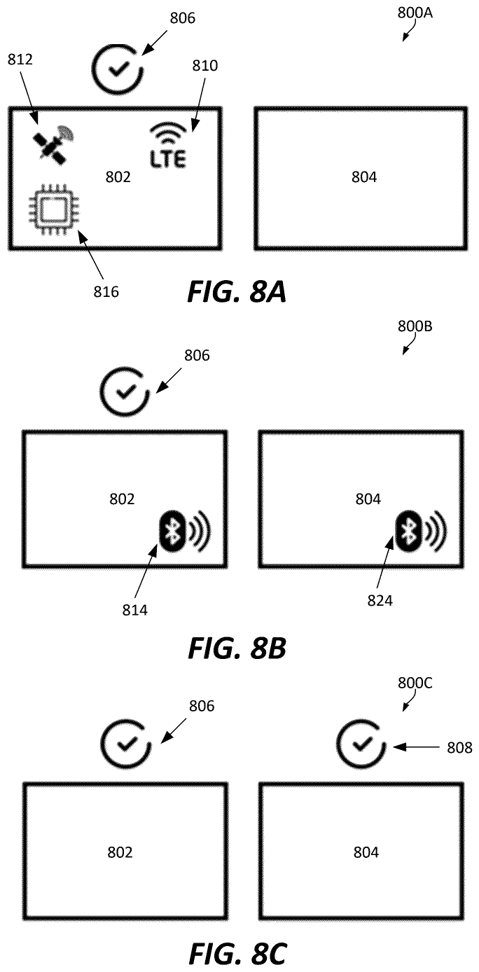

FIGS. 8A-C illustrates an example system 800 that allows for determination of a motion state of device 804. Device 804 may lack the necessary modules for determination of motion states by itself. Device 804 may be similar to device 604. Device 802 may be similar to device 602 and may include GNSS module 812, radio module 810, and IMU 816 and may, thus, be configured to determine motion states in accordance with the techniques described herein.

In FIG. 8A, device 802 may determine motion state 806 with GNSS module 812, radio module 810, and/or IMU 816 according to the techniques described herein. Based on the determined motion state, device 802 and/or device 804 may determine that device 804 is disposed proximate to device 802 and that device 802 is still in communication with device 804 even while device 802 is in motion. Thus, device 802 may, with communication module 814, communicatively couple with device 804 via communication module 824 in FIG. 8B. When communicatively coupled, in FIG. 8C, the motion state of device 802 may also be communicated or imparted to device 804. Thus, device 804 may be determined to be in motion state 808, which may be the same motion state as motion state 806.

### Device Example

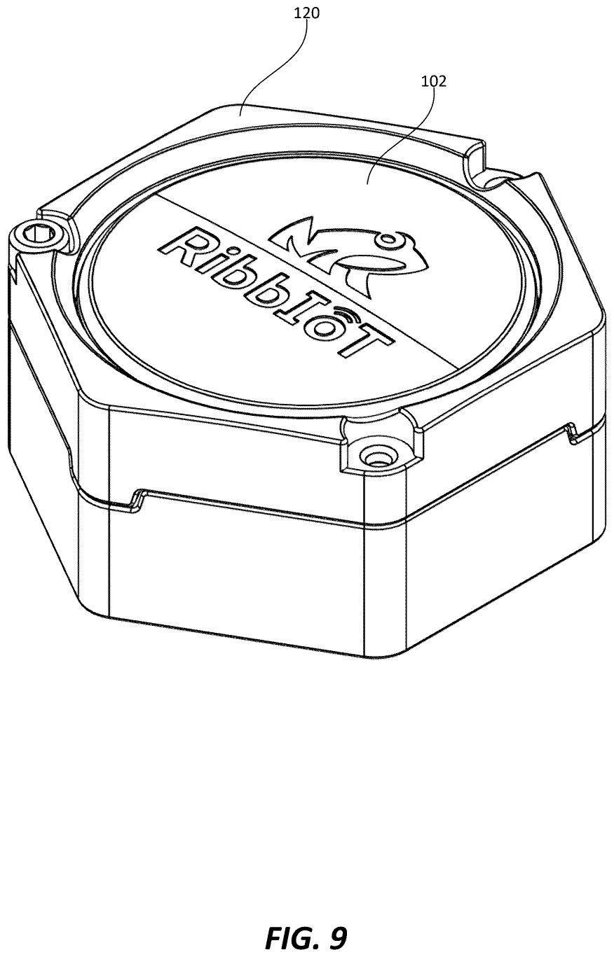

FIG. 9 illustrates a perspective view of a commercial equipment tracking device, in accordance with certain embodiments. As shown in FIG. 9, tracking pod 102 may be disposed within housing 120. Tracking pod 102 may be a tracking pod as described herein and may or may not include one or more of a GNSS module, radio module, or IMU.

Housing 120 may be configured to couple to certain commercial equipment. In various embodiments, housing 120 may be configured to couple to the commercial equipment via one or more different techniques, such as through bolting, screwing, welding, adhesives, and/or other such techniques. As such, housing 120 may be securely coupled to commercial equipment and may minimally move when coupled to commercial equipment.

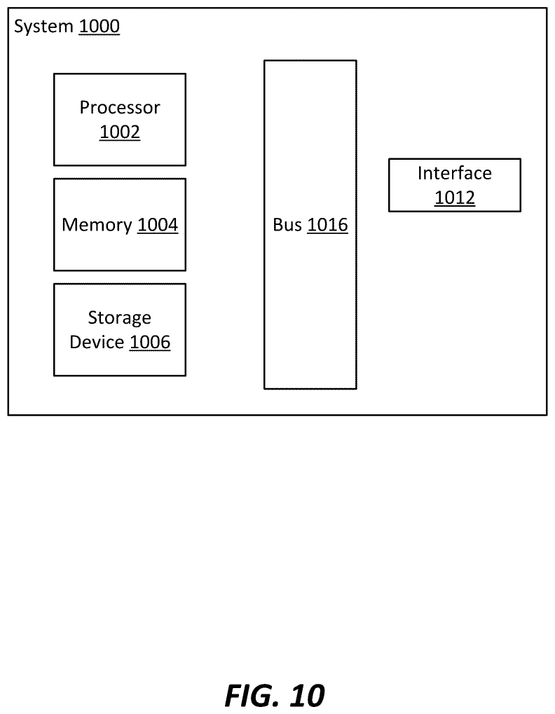

FIG. 10 illustrates a block diagram of an example computing system, in accordance with certain embodiments. According to various embodiments, a system 1000 suitable for implementing embodiments described herein includes a processor 1002, a memory module 1004, a storage device 1006, an interface 1012, and a bus 1016 (e.g., a PCI bus or other interconnection fabric.) System 1000 may operate as variety of devices such as a server system such as an application server and a database server, a client system such as a laptop, desktop, smartphone, tablet, wearable device, set top box, etc., or any other device or service described herein.

Although a particular configuration is described, a variety of alternative configurations are possible. The processor 1002 may perform operations such as those described herein. Instructions for performing such operations may be embodied in the memory 1004, on one or more non-transitory computer readable media, or on some other storage device. Various specially configured devices can also be used in place of or in addition to the processor 1002. The interface 1012 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed embodiments may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

### Conclusion

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various embodiments have been described herein, it should be understood that they have been presented by way of example only, and not limitation. For example, some techniques and mechanisms are described herein in the context of fulfillment.

However, the disclosed techniques apply to a wide variety of circumstances. Particular embodiments may be implemented without some or all of the specific details described herein. In other instances, well known process operations have not been described in detail in order not to unnecessarily obscure the techniques disclosed herein.

Accordingly, the breadth and scope of the present application should not be limited by any of the embodiments described herein, but should be defined only in accordance with the claims and their equivalents.

1. A commercial equipment tracking system, comprising:
a first commercial equipment tracking device, configured to couple to a first equipment and comprising:
a first communications module;
a first processor, communicatively coupled to the first communications module and configured to perform operations comprising:
determining, during a first time period, that the first equipment is in a zero motion state;
receiving, during a second time period later than the first time period, first data of a first protocol;
determining, based on the first data received during the second time period, that the first equipment is in a second motion state;
communicating, via the first communications module to a server, first state data indicating that the equipment is in the second motion state;
receiving, during a third time period later than the second time period, second data of a second protocol different from the first protocol;
determining, based on the second data and a lack of further first data, that the first equipment is in a first motion state;
determining, during a fourth time period later than the third time period, a lack of further first data for a first threshold period of time;
determining, based on the lack of further first data for the first threshold period of time, that the first equipment is in a zero motion state; and
communicating, via the first communications module to the server, second state data indicating that the equipment is in the zero motion state.

2. The commercial equipment tracking system of claim 1, wherein the first commercial equipment tracking device further comprises:
a first data receiver, configured to receive the first data of the first protocol.

3. The commercial equipment tracking system of claim 2, wherein the first commercial equipment tracking device further comprises:
a second data receiver, configured to receive the second data of the second protocol.

4. The commercial equipment tracking system of claim 2, wherein the second data of the second protocol is received by the first communications module from an associated device.

5. The commercial equipment tracking system of claim 1, wherein the first commercial equipment tracking device further comprises:
a third data receiver, configured to receive the third data of a third protocol, and wherein the operations further comprise:
receiving, at the third time period, third data of the third protocol, wherein the determining that the first equipment is in the first motion state is further based on the third data.

6. The commercial equipment tracking system of claim 1, wherein the first data and the second data is received by the first communications module from an associated device coupled to second equipment, and wherein:
the determining the second motion state further comprises determining that the second equipment is in the second motion state; and
the determining the first motion state further comprises determining that the second equipment is in the first motion state.

7. The commercial equipment tracking system of claim 1, wherein the operations further comprise:
receiving, during a fifth time period later than the fourth time period, second data of the second protocol and/or third data of a third protocol; and
determining, based on the second data and/or the third data received during the fifth time period, that the first equipment is in a third motion state.

8. The commercial equipment tracking system of claim 7, wherein the operations further comprise:
determining that the first equipment is in the third motion state for a second threshold period of time;
determining, based on the first equipment being determined to be in the third motion state for the second threshold period of time, that the first equipment is in the zero motion state; and
communicating, via the first communications module to the server, third state data indicating that the equipment is in the zero motion state.

9. The commercial equipment tracking system of claim 7, wherein the operations further comprise:
receiving, during a sixth time period later than the fifth time period, first data of the first protocol, second data of the second protocol, and/or third data of the third protocol;
determining, based on the first data, second data, and/or third data received during the sixth time period, that the first equipment is in the second motion state;
communicating, via the first communications module to the server, third state data indicating that the equipment is in the second motion state.

10. The commercial equipment tracking system of claim 7, wherein the first protocol is a Global Navigation Satellite System protocol, the second protocol is an inertial measurement protocol, and the third protocol is a communications signal based protocol.

11. A method of operating a first commercial equipment tracking device coupled to a first equipment, the method comprising:
determining, during a first time period, that the first equipment is in a zero motion state;
receiving, during a second time period later than the first time period, first data of a first protocol;
determining, based on the first data received during the second time period, that the first equipment is in a second motion state;
communicating, via a first communications module of the first commercial equipment tracking device to a server, first state data indicating that the equipment is in the second motion state;
receiving, during a third time period later than the second time period, second data of a second protocol different from the first protocol;
determining, based on the second data and a lack of further first data, that the first equipment is in a first motion state;
determining, during a fourth time period later than the third time period, a lack of further first data for a first threshold period of time;
determining, based on the lack of further first data for the first threshold period of time, that the first equipment is in a zero motion state; and
communicating, via the first communications module to the server, second state data indicating that the equipment is in the zero motion state.

12. The method of claim 11, wherein the first data of the first protocol is received with a first data receiver of the first commercial equipment tracking device.

13. The method of claim 12, wherein the second data of the second protocol is received with a second data receiver of the first commercial equipment tracking device.

14. The method of claim 12, wherein the second data of the second protocol is received by the first communications module from an associated device.

15. The method of claim 11, further comprising:
receiving, at the third time period, third data of a third protocol, wherein the determining that the first equipment is in the first motion state is further based on the third data, and wherein the third data of the third protocol is received with a third data receiver of the first commercial equipment tracking device.

16. The method of claim 11, wherein the first data and the second data are received by the first communications module from an associated device coupled to second equipment, and wherein:
the determining the second motion state further comprises determining that the second equipment is in the second motion state; and
The determining the first motion state further comprises determining that the second equipment is in the first motion state.

17. The method of claim 11, further comprising:
receiving, during a fifth time period later than the fourth time period, second data of the second protocol and/or third data of a third protocol; and
determining, based on the second data and/or the third data received during the fifth time period, that the first equipment is in a third motion state.

18. The method of claim 17, further comprising:
determining that the first equipment is in the third motion state for a second threshold period of time;
determining, based on the first equipment being determined to be in the third motion state for the second threshold period of time, that the first equipment is in the zero motion state; and
communicating, via the first communications module to the server, third state data indicating that the equipment is in the zero motion state.

19. The method of claim 17, further comprising:
receiving, during a sixth time period later than the fifth time period, first data of the first protocol, second data of the second protocol, and/or third data of the third protocol;
determining, based on the first data, second data, and/or third data received during the sixth time period, that the first equipment is in the second motion state;
communicating, via the first communications module to the server, third state data indicating that the equipment is in the second motion state.

20. The method of claim 17, wherein the first protocol is a Global Navigation Satellite System protocol, the second protocol is an inertial measurement protocol, and the third protocol is a communications signal based protocol.
